(19) United States
(12) Patent Application Publication
(10) Pub. No.: US 2009/0002983 A1
(43) Pub. Date: Jan. 1, 2009

(54) Ornament structure

(76) Inventor: Ching-Hui Lee, Guangzhou City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/819,519

(22) Filed: Jun. 28, 2007

(51) Int. Cl. F21V 7/00

(52) U.S. Cl. 362/235

(57) ABSTRACT

An ornament includes a base, a power source connected with the base, a switch on the base, a circuit board positioned on the base, several light sources connected with the circuit board, and a covering part positioned on a front side of the circuit board; the circuit board, the power source, and the switch together comprise a circuit; the circuit board has a middle raised portion, and a reflection layer, which covers the raised portion; the covering part includes a pervious-to-light plate, which is arranged at a middle, and has a plating membrane thereon; thus, when the light sources are emitting light, the reflection layer and the plating membrane of the pervious-to-light plate together can help to produce such an optical effect that the ornament itself presents multiple light-spots, and looks as if it comprised an inwardly extending multi-sectional tunnel.

### BACKGROUND OF THE INVENTION

1. Field of the Invention

The present invention relates to an ornament structure, more particularly one, which can emit light in such a manner that the light sources of the ornament look they have three-dimensional depth, and that it itself presents multiple light-spots to look like it comprises an inwardly extending multi-sectional tunnel.

2. Brief Description of the Prior Art

Every room has a soul, and houses of the same layout can have their respective interior design. More and more people have a taste for the dwelling houses having their individuality, and would design and decorate their dwelling houses themselves. Many people would beautify their dwelling houses with various little ornaments. And, many modern people would find it is very pressure-relaxing, entertaining and inspiring to design and decorate their own houses themselves.

Shown in FIGS. 5 and 6 is a currently existing ornament structure. The ornament structure includes a base 5, a circuit board 6, a plate part 7, and a covering part 8. The base 5 comprises a hollow holding portion 51 on a front side, and has an electrode plate 52 secured in the hollow holding portion 51, and batteries 53 are connected with the electrode plate 52. The base 5 is equipped with a switch 54, which is beside the hollow holding portion 51. The circuit board 6 is joined to the base 5, and comprises a circuit together with the batteries 53 and the switch 54. The circuit board 6 is equipped with several light sources 61, which are spaced apart on a periphery of the circuit board 6. The plate part 7 is printed with a design 71, and positioned on a front side of the circuit board 6. The covering part 8 is secured on a front side of the plate part 7, and it comprises a pervious-to-light plate 81, which is arranged on the middle. The pervious-to-light plate 81 has several raised lines formed on a rear side thereof to face the design 71 of the plate part 7. Owing to the raised lines 811 of the pervious-to-light plate 81, the design 71 of the plate part 7 will look as if they were emitting light themselves, and will be more attractive when the light sources 61 are shining. However, the design can't be made to look like they are three-dimensional by means of the pervious-to-light plate. Consequently, the ornament isn't attractive enough to those people who like to buy and use fancy things.

### SUMMARY OF THE INVENTION

It is a main object of the present invention to provide an improvement on an ornament structure to overcome the above problem.

An ornament structure according to an embodiment of the present invention includes a base, a power source connected with the base, a switch, a circuit board on the base, several light sources connected with the circuit board, and a covering part arranged in front of a front side of the circuit board. The circuit board, the power source, and the switch together comprise a circuit. The circuit board has a middle raised portion, and a reflection layer on the front side, which covers the raised portion. The covering part includes a pervious-to-light plate, which is arranged at the middle, and has a plating membrane thereon. When the light sources are emitting light, the reflection layer and the plating membrane of the pervious-to-light plate together will help the light produce a special visual effect such that the ornament presents multiple light-spots, and looks like it comprises an inwardly extending multi-sectional tunnel.

### BRIEF DESCRIPTION OF THE DRAWINGS

The present invention will be better understood by referring to the accompanying drawings, wherein:

FIG. 1 is an exploded perspective view of the present invention,

FIG. 2 is a lateral sectional view of the present invention,

FIG. 3 is a lateral sectional view of the present invention in use,

FIG. 4 is an exploded perspective view of a second preferred embodiment in the invention,

FIG. 5 is an exploded perspective view of the prior art, and

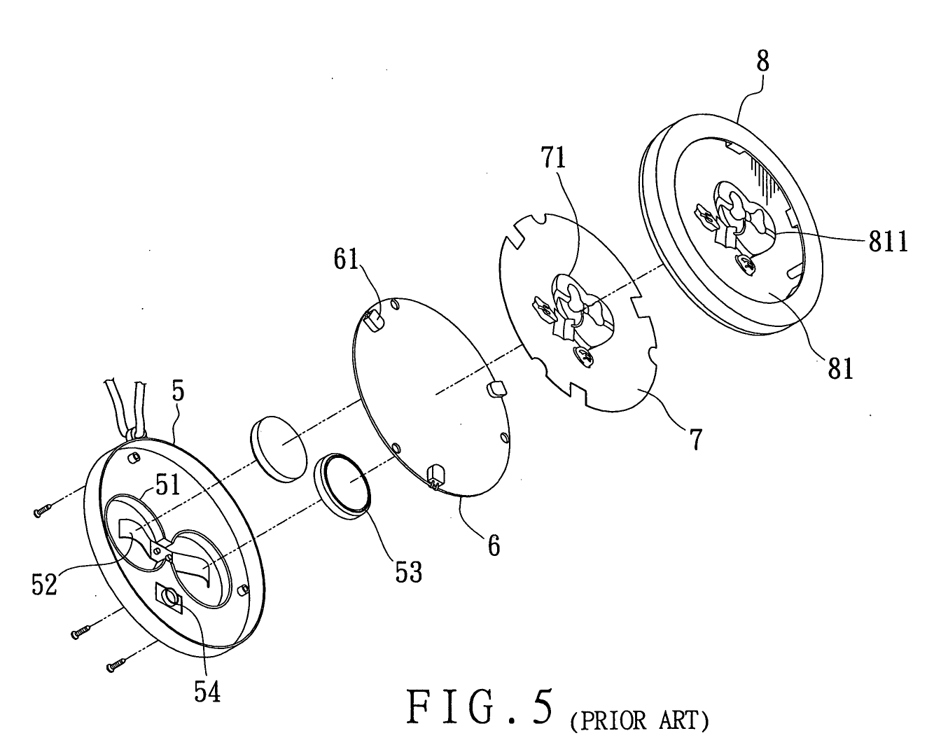

FIG. 6 is a lateral sectional view of the prior art.

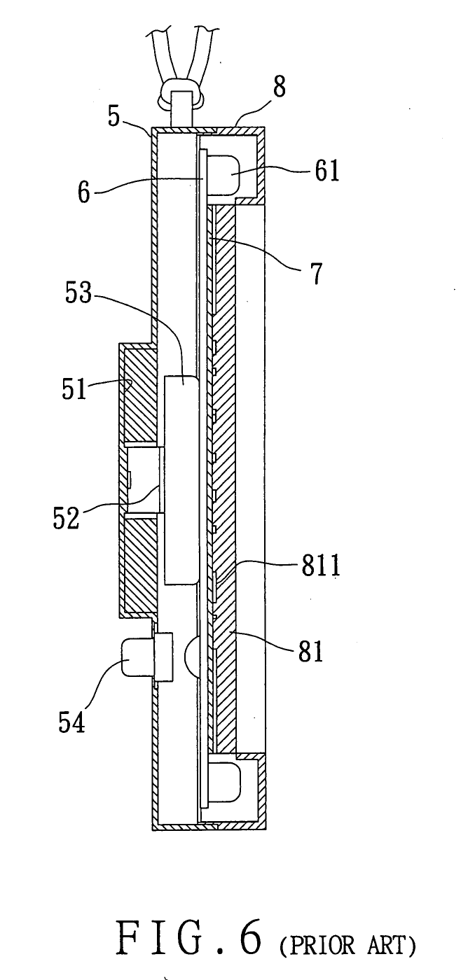

### DETAILED DESCRIPTION OF THE PREFERRED EMBODIMENTS

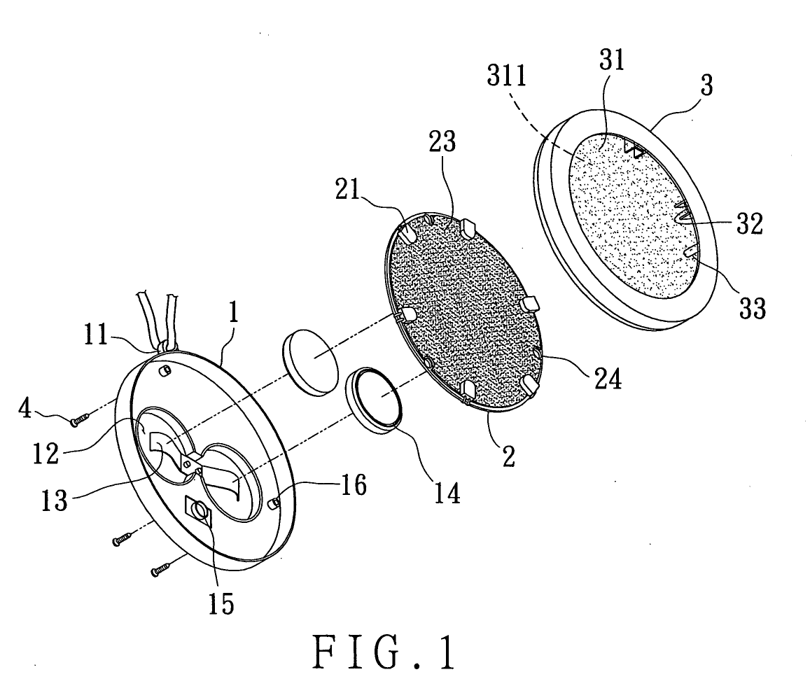

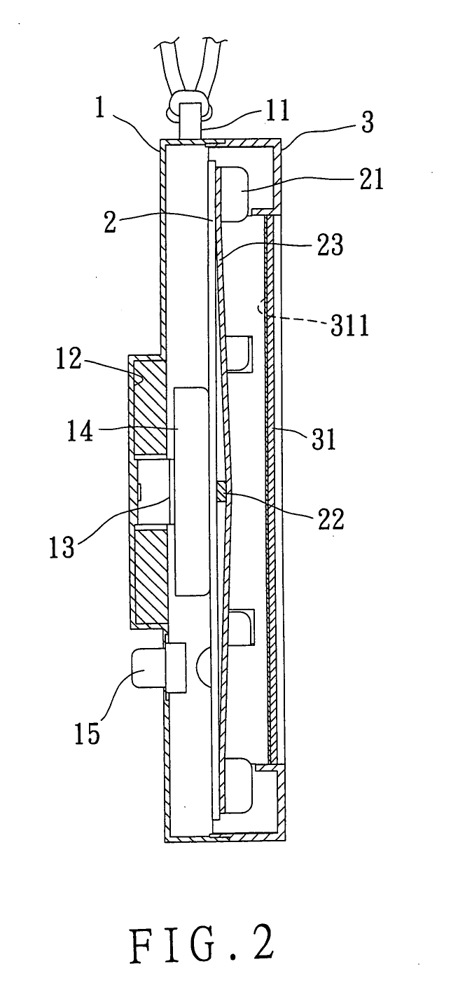

Referring to FIGS. 1 and 2, a preferred embodiment of an ornament of the present invention includes a base 1, a circuit board 2, and a covering part 3.

The base 1 comprises a hanging ring 11 on a top thereof to be joined to a cord. The base 1 comprises a hollow holding portion 12 on a front side, and is equipped with an electrode plate 13, which is secured in the hollow holding portion 12 to be connected with a power source 14 such as a battery set. The base 1 is equipped with a switch 15, which is beside the hollow holding portion 12, and which sticks out from a rear of the base 1 at a tip thereof for a user to press. The base 1 further has several screw holes 16 beside the hollow holding portion 12.

The circuit board 2 is securely joined to the front side of the base 1. The circuit board 2 is equipped with several light sources 21, which are spaced apart on a periphery of the circuit board 2; the light sources 21 can be light emitting diodes (LED). The circuit board 2 has a raised portion 22 on a middle of a front side thereof, and a reflection layer 23 on the front side thereof to help increase brightness of the light sources 21, with a middle portion of the reflection layer 23 being propped on the raised portion 22. The circuit board 2 further has several through holes 24 to face corresponding said screw holes 16 of the base 1.

The covering part 3 is securely joined to the base 1 and the circuit board 2 by means of threaded fixing elements 4. The covering part 3 comprises a pervious-to-light plate 31, which is arranged on the middle. The pervious-to-light plate 31 includes a plating membrane 311 on the surface. A periphery of the pervious-to-light plate 31 is formed with several cavities 32 to face corresponding said light sources 21 on the circuit board 2. The covering part 3 has several screw holes 33 to face corresponding said screw holes 16 of the base 1.

In assembly, the circuit board 2 is positioned on the front side of the base 1, and the covering part 3 on the front side of the circuit board 2, with the light sources 21 being received in the cavities 32 of the covering part 3, and the threaded fixing elements 4 are passed through the screw holes 16 of the base 1, the through holes 24 of the circuit board 2, and the screw holes 33 of the covering part 3. Thus, the circuit board 2, the power source 14, and the switch 15 of the base 1 comprise a circuit, and the switch 15 can be operated to turn on/off the circuit.

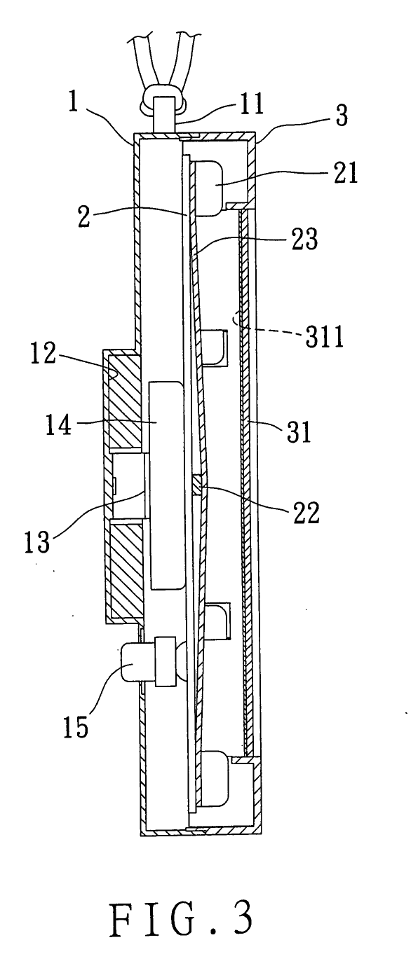

Shown in FIG. 3 is the ornament of the present invention in use. To use the ornament, first the user presses the switch 15 on the base 1 so as to turn on the light sources 21 provided on the periphery of the circuit board 2; the light sources 21 can shine one after another or flash on and off. Because the middle portion of the reflection layer 23 is propped on the raised portion 22 provided on the middle of the front side of the circuit board 2, light of the light sources 21 will make the light sources 21 look like they have three-dimensional depth when reflected by the reflection layer 23; the depth and intersection of light can be changed by means of adjusting the raised portion 22. Furthermore, the reflection layer 23 and the plating membrane 311 of the pervious-to-light plate 31 together will help to produce such an optical effect that the ornament of the present invention comprises multiple light-spots so as to look as if it had an inwardly extending multi-sectional tunnel.

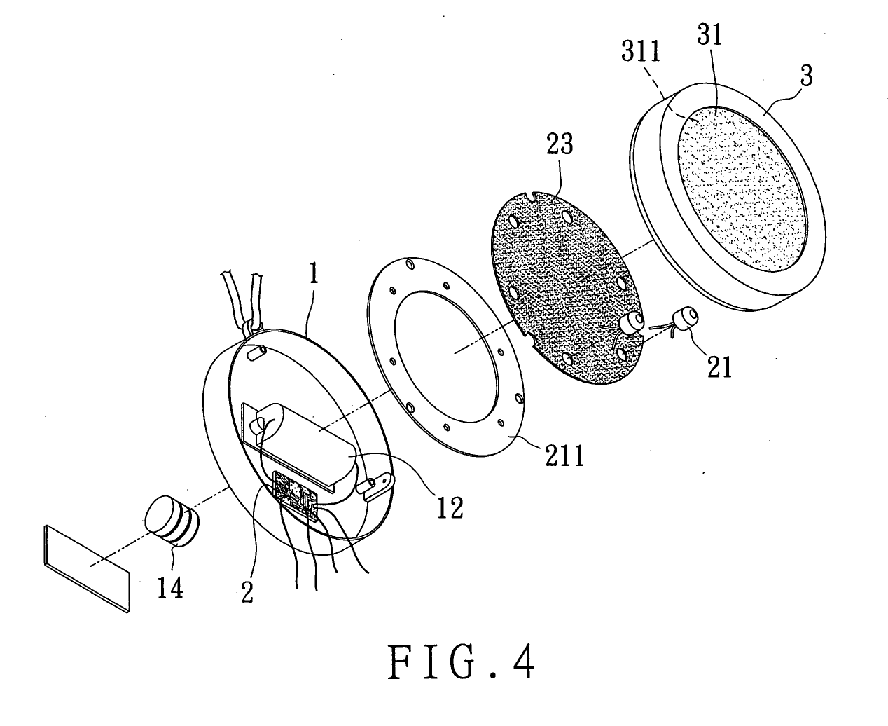

Shown in FIG. 4 is a second preferred embodiment of an ornament of the present invention. The ornament includes a base 1, which has a hollow holding portion 12 on a rear thereof for connection with a power source 14. The ornament includes a circuit board 2 secured on the base 1, a ringed fixing board 211, and several light sources 21. The light sources 21 are secured on the ringed fixing board 211, electrically connected to the circuit board 2, and stick out through a reflection layer 23 on the circuit board 2. The ornament further includes a covering part 3 securely disposed on a front side of the base 1. The covering part 3 comprises a middle pervious-to-light plate 31, which has a plating membrane 311.

From the above description, it can be seen that the ornament of the present invention has the following advantages over the prior art:

The circuit board has a reflection layer therefore brightness of the light sources is increased. When light emitted from the light sources is reflected by the reflection layer of the front side of the circuit board, the light sources will look like they have three-dimensional depth owing to the existence of the raised portion on the middle of the front side of the circuit board and the pervious-to-light plate with the plating membrane; thus, the ornament produces changeful light, and is more commercially valuable. The reflection layer and the plating membrane of the pervious-to-light plate together can help to produce such an optical effect that the ornament itself presents multiple light-spots to look as if it comprised an inwardly extending multi-sectional tunnel; in other words, the present invention can produce a special visual effect.

1. An ornament structure, comprising
a base, the base being connected with a power source; the base being equipped with a switch;
a circuit board positioned on the base, the circuit board, the power source, and the switch together comprising a circuit; the circuit board having a reflection layer having a raised central portion;
a plurality of light sources connected with the circuit board and disposed peripherally about the raised central portion of said reflection layer; and
a covering part covering the circuit board, the covering part including a pervious-to-light plate with a plating membrane;
whereby said reflection layer and said plating membrane are cooperatively disposed to direct light generated by the light sources in a pattern visually radiating relative to the raised central portion.

2. The ornament structure as claimed in claim 1, wherein the base has a hanging ring thereon to be joined to a cord.

3. The ornament structure as claimed in claim 1, wherein the base includes a hollow holding portion, and an electrode plate is secured in the hollow holding portion of the base to be connected with the power source and the switch.

4. The ornament structure as claimed in claim 1, wherein the power source includes a plurality of batteries.

5. The ornament structure as claimed in claim 1, wherein the switch sticks out from a rear of the base at a tip thereof.

6. The ornament structure as claimed in claim 1, wherein the base has a plurality of screw holes, and the circuit board has a plurality of though holes each facing a corresponding said screw hole of the base, and the covering part has a plurality of screw holes each facing a corresponding said screw hole of the base.

7. The ornament structure as claimed in claim 1, wherein the light sources are light emitting diodes.

8. The ornament structure as claimed in claim 1, wherein a periphery of the pervious-to-light plate is formed with a plurality of cavities each facing a corresponding said light source.

9. The ornament structure as claimed in claim 1, wherein a raised portion is provided between the circuit board and the reflection layer to support said central raised portion of said reflection layer.

10. The ornament structure as claimed in claim 1, wherein the light sources are directly secured on the circuit board.

11. The ornament structure as claimed in claim 1, wherein the light sources are secured on a fixing board, and connected with the circuit board.

12. The ornament structure as claimed in claim 11, wherein the fixing board is ring-shaped.
